(19) United States
(12) Patent Application Publication
(10) Pub. No.: US 2022/0166052 A1
(43) Pub. Date: May 26, 2022

(54) ELECTRODE FOR USE IN LITHIUM-ION SECONDARY BATTERIES

(71) Applicant: HONDA MOTOR CO., LTD., Tokyo (JP)

(72) Inventor: Kazuki SAIMEN, Saitama (JP)

(21) Appl. No.: 17/455,408

(22) Filed: Nov. 17, 2021

(30) Foreign Application Priority Data
Nov. 20, 2020 (JP) 2020-193262

(51) Int. Cl. H01M 10/0525; H01M 4/36; H01M 4/04; H01M 4/62; H01M 4/583

(52) U.S. Cl. CPC H01M 10/0525; H01M 4/366; H01M 4/0407; H01M 2004/028; H01M 4/622; H01M 4/583; H01M 4/625

(57) ABSTRACT

Provided is an electrode that is for use in lithium-ion secondary batteries, makes lithium-ion secondary batteries less vulnerable to a decline in capacity during charge and discharge cycles, and allows lithium-ion secondary batteries to have high durability to charge and discharge cycles. The electrode for use in lithium-ion secondary batteries includes an electrode material mixture layer including an electrode active material and a high-dielectric inorganic solid, in which the electrode active material has a surface site in contact with the high-dielectric inorganic solid and has another surface site to be in contact with an electrolytic solution, and the high-dielectric inorganic solid is a Na- or Mg-based high-dielectric inorganic solid.

This application is based on and claims the benefit of priority from Japanese Patent Application No. 2020-193262, filed on 20 Nov. 2020, the content of which is incorporated herein by reference.

### BACKGROUND OF THE INVENTION

### Field of the Invention

The present invention relates to an electrode for use in lithium-ion secondary batteries and to a lithium-ion secondary battery.

### Related Art

The conventional art provides a wide variety of lithium-ion secondary batteries including a lithium ion conducting solid electrolyte. For example, a known lithium-ion secondary battery contains an active material coated with a coating layer including a lithium ion conducting solid electrolyte and a conductive aid, in which the active material is contained in the positive or negative electrode (see, for example, Patent Document 1).

According to Patent Document 1, the coating layer including a lithium ion conducting solid electrolyte and a conductive aid, with which the active material is coated in the positive or negative electrode, can reduce the internal resistance of the lithium-ion secondary battery and protect the active material from deformation during charge and discharge to prevent a decline in charge and discharge cycle characteristics or high-rate discharge characteristics.

Patent Document 1: Japanese Unexamined Patent Application, Publication No. 2003-59492

### SUMMARY OF THE INVENTION

Unfortunately, the lithium-ion secondary battery disclosed in Patent Document 1 has the problem of a rapid decline in durability to charge and discharge operations, although it can produce the above advantageous effects in early charge and discharge cycles.

It is an object of the present invention to provide a solution to the problem and to provide an electrode that is for use in lithium-ion secondary batteries, makes lithium-ion secondary batteries less vulnerable to a decline in capacity during charge and discharge cycles, and allows lithium-ion secondary batteries to have high durability to charge and discharge cycles. It is another object of the present invention to provide a lithium-ion secondary battery including such an electrode.

The present invention has the following aspects.

(1) An electrode for use in a lithium-ion secondary battery, the electrode including: an electrode material mixture layer including an electrode active material and a high-dielectric inorganic solid, the electrode active material having a surface site in contact with the high-dielectric inorganic solid and having another surface site to be in contact with an electrolytic solution, the high-dielectric inorganic solid being a Na- or Mg-based high-dielectric inorganic solid.

According to aspect (1) of the invention, the Na- or Mg-based high-dielectric inorganic solid, which is chemically stable, can trap a solvent due to its high dielectric effect, which makes it possible to provide an electrode that is for use in lithium-ion secondary batteries, makes lithium-ion secondary batteries less vulnerable to an increase in internal resistance during charge and discharge cycles, and allows lithium-ion secondary batteries to have high durability to charge and discharge cycles.

(2) The electrode for use in a lithium-ion secondary battery according to aspect (1), in which the high-dielectric inorganic solid is provided between particles of the electrode active material or on the surface of a particle of the electrode active material.

According to aspect (2) of the invention, the high-dielectric inorganic solid provided between particles of the electrode active material can effectively trap an electrolytic solution in the interior of the electrode and can reduce the internal resistance.

(3) The electrode for use in a lithium-ion secondary battery according to aspect (1) or (2), in which the high-dielectric inorganic solid is any one of an oxide, a fluoride, a chloride, and a sulfide.

According to aspect (3) of the invention, the high-dielectric inorganic solid may be any one of an oxide, a fluoride, a chloride, and a sulfide.

(4) The electrode for use in a lithium-ion secondary battery according to any one of aspects (1) to (3), being a negative electrode.

The negative electrode according to aspect (4) of the invention can form a lithium-ion secondary battery having high charge capacity at low temperature and having high quick charge performance and high durability.

(5) The electrode for use in a lithium-ion secondary battery according to aspect (4), in which the high-dielectric inorganic solid is a sodium-based inorganic compound resistant to reductive decomposition.

According to aspect (5) of the invention, the high-dielectric inorganic solid is resistant to decomposition and can have a sustained solvent-trapping effect to make the electrode more durable.

(6) The electrode for use in a lithium-ion secondary battery according to aspect (5), in which the sodium-based inorganic compound resistant to reductive decomposition has a reductive decomposition potential of 1.5 V or less relative to the Li/Li⁺ equilibrium potential (1.5 V vs Li/Li⁺).

In the negative electrode according to aspect (6) of the invention, the reductive decomposition-resistant, lithium ion conductive, solid electrolyte with a reductive decomposition potential of 1.5 V or less relative to the Li/Li⁺ equilibrium potential is resistant to reductive decomposition into component metal elements during charging, which would otherwise cause elution of component metal and structural change to reduce the lithium ion conductivity.

(7) The electrode for use in a lithium-ion secondary battery according to aspect (5) or (6), in which the sodium-based inorganic compound resistant to reductive decomposition has a relative permittivity of 10 or more.

According to aspect (7) of the invention, the reductive decomposition-resistant, sodium-based inorganic compound particles can be polarized to trap an acid, which may be produced if fluoride anions, such as PF₆⁻, or a solvent undergoes decomposition on the surface of negative electrode graphite. An acid produced in the interior of a secondary battery can corrode the positive electrode active material. When the produced acid is trapped, the positive electrode active material can be prevented from corroding and thus protected from corrosion and from charge and discharge-induced cracking or metal elution, which makes the secondary battery less vulnerable to an increase in resistance during charge and discharge cycles.

(8) The electrode for use in a lithium-ion secondary battery according to any one of aspects (5) to (7), in which the sodium-based inorganic compound resistant to reductive decomposition includes Na³⁺ₓ (Sb₁₋ₓ, Snₓ)S₆, wherein 0≤x≤0.1.

Aspect (8) of the invention is effective in improving the durability of the electrode.

(9) The electrode for use in a lithium-ion secondary battery according to any one of aspects (5) to (8), in which the electrode material mixture contains 0.1 wt % or more and 1.0 wt % or less of the sodium-based inorganic compound resistant to reductive decomposition.

Aspect (9) of the invention is effective in improving the durability of the electrode.

(10) The electrode for use in a lithium-ion secondary battery according to any one of aspects (1) to (3), being a positive electrode.

The positive electrode according to aspect (10) of the invention can form a lithium-ion secondary battery having high durability to output power and charge and discharge cycles.

(11) The electrode for use in a lithium-ion secondary battery according to aspect (10), in which the high-dielectric inorganic solid is a sodium-based inorganic compound resistant to oxidative decomposition.

According to aspect (11) of the invention, the high-dielectric inorganic solid is resistant to decomposition and can have a sustained solvent-trapping effect to make the electrode more durable.

(12) The electrode for use in a lithium-ion secondary battery according to aspect (11), in which the sodium-based inorganic compound resistant to oxidative decomposition has an oxidative decomposition potential of 4.5 V or more relative to the Li/Li⁺ equilibrium potential (4.5 V vs Li/Li⁺).

In the positive electrode according to aspect (12) of the invention, the oxidative decomposition-resistant, lithium ion conductive solid electrolyte with an oxidative decomposition potential of 4.5 V or more relative to the Li/Li⁺ equilibrium potential is resistant to oxidative decomposition into component metal elements during charging, which would otherwise cause elution of component metal and structural change to reduce the lithium ion conductivity.

(13) The electrode for use in a lithium-ion secondary battery according to aspect (11) or (12), in which the sodium-based inorganic compound resistant to oxidative decomposition has a relative permittivity of 10 or more.

Aspect (13) of the invention makes a secondary battery less vulnerable to an increase in resistance during charge and discharge cycles.

(14) The electrode for use in a lithium-ion secondary battery according to any one of aspects (11) to (13), in which the sodium-based inorganic compound resistant to oxidative decomposition is at least one of Na³⁺ₓ(Sb₁₋ₓ, Snₓ)S₄, wherein 0≤x≤0.1, and Na₃Zr₂Si₂PO₁₂.

Aspect (14) of the invention is effective in improving the durability of the electrode.

(15) The electrode for use in a lithium-ion secondary battery according to any one of aspects (11) to (14), in which the electrode material mixture contains 0.5 wt % or more and 1.0 wt % or less of the sodium-based inorganic compound resistant to oxidative decomposition.

Aspect (15) of the invention is effective in improving the durability of the electrode.

(16) A lithium-ion secondary battery including the electrode according to any one of aspects (1) to (15).

Aspect (16) of the invention provides a lithium-ion secondary battery having high durability.

### BRIEF DESCRIPTION OF THE DRAWINGS

FIG. 1 is a cross-sectional view of a lithium-ion secondary battery according to an embodiment of the present invention;

FIG. 2 is a schematic diagram showing an active material for use in a lithium-ion secondary battery according to an embodiment of the present invention; and

FIG. 3 is a schematic view showing the electrolytic solution-stabilizing effect of the Na-based inorganic compound according to an embodiment of the present invention.

### DETAILED DESCRIPTION OF THE INVENTION

Hereinafter, embodiments of the present invention will be described with reference to the drawings. The embodiments described below are not intended to limit the scope of the present invention.

Lithium-Ion Secondary Battery

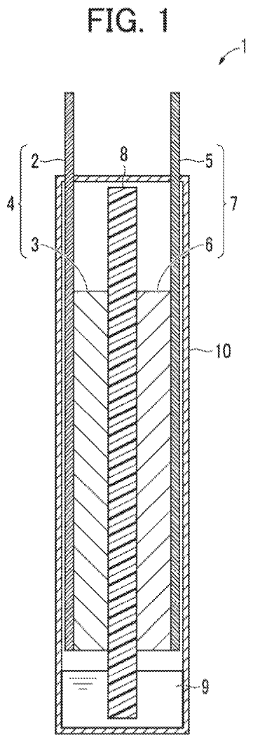

FIG. 1 shows a lithium-ion secondary battery 1 according to an embodiment of the present invention including a positive electrode 4, a negative electrode 7, a separator 8, an electrolytic solution 9, and a case 10. The positive electrode 4 includes a positive electrode current collector 2 and a positive electrode material mixture layer 3 provided on the positive electrode current collector 2. The negative electrode 7 includes a negative electrode current collector 5 and a negative electrode material mixture layer 6 provided on the negative electrode current collector 5. The separator 8 electrically insulates the positive electrode 4 and the negative electrode 7. The case 10 accommodates the positive electrode A, the negative electrode 7, the separator 8, and the electrolytic solution 9.

In the case 10, the positive electrode material mixture layer 3 and the negative electrode material mixture layer 6 face each other with the separator 8 in between them. The electrolytic solution 9 is stored below the positive electrode mixture material layer 3 and the negative electrode material mixture layer 6. An end portion of the separator 8 is immersed in the electrolytic solution 9.

Electrode Material Mixture Layers

The positive electrode material mixture layer 3 includes a positive electrode active material 11, a conductive aid, and a binding agent (binder). The negative electrode material mixture layer 6 includes a negative electrode active material 12, a conductive aid, and a binding agent (binder). At least one of the positive and negative material mixture layers 3 and 6 contains a high-dielectric inorganic solid 13.

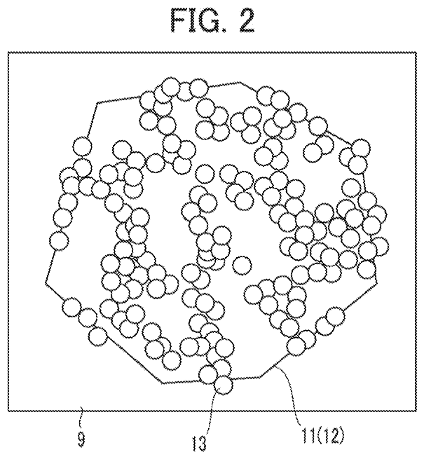

When the positive electrode material mixture layer 3 or the negative electrode material mixture layer 6 contains the high-dielectric inorganic solid 13, the positive electrode active material 11 or the negative electrode active material 12 has a surface site in contact with the high-dielectric inorganic solid 13 and another surface site in contact with the electrolytic solution 9 as shown in FIG. 2. Specifically, the positive electrode active material 11 or the negative electrode active material 12 is in contact with the high-dielectric inorganic solid 13 at a part of its surface and in contact with the electrolytic solution 9 at the remaining part of its surface.

In the positive electrode 4 or the negative electrode 7 of the lithium-ion secondary battery 1 according to an embodiment of the present invention, the positive electrode active material 11 or the negative electrode active material 12 has a surface site in contact with the high-dielectric inorganic solid 13 and another surface site in contact with the electrolytic solution 9. Thus, the electrolytic solution 9 can reduce the surface potential of the positive electrode active material 11 or the negative electrode active material 12 and reduce lithium-ion interface resistance between the positive electrode active material 11 or the negative electrode active material 12 and the high-dielectric inorganic solid 13. This results in a reduction in the lithium-ion transfer resistance between the positive electrode active material 11 or the negative electrode active material 12 and the high-dielectric inorganic solid 13, so that the increase in internal resistance can be kept at a low level during charge and discharge cycles.

In the positive electrode 4 or the negative electrode 7 of the lithium-ion secondary battery 1 according to an embodiment of the present invention, the positive electrode active material 11 or the negative electrode active material 12 has a surface site, in contact with the electrolytic solution 9. The surface site provides sufficient contact with the electrolytic solution 9. Therefore, decomposition of the solvent is significantly prevented at the surface of the active material so that the consumption of the electrolytic solution can be saved, whereas such decomposition may occur when the active material surface is less impregnated with the electrolytic solution in the conventional art.

Therefore, depletion of the electrolytic solution 9 is prevented at the positive electrode 4 or the negative electrode 7 of the lithium-ion secondary battery 1 according to the embodiment. Accordingly, good contact condition is maintained between the electrolytic solution 9 and the surface of the positive electrode active material 11 or the negative electrode active material 12 in the electrode. This provides a uniform potential in the electrode and prevents a localized high or low potential. In the lithium-ion secondary battery 1, therefore, the active material itself is significantly prevented from undergoing oxidative decomposition reaction in the positive electrode 4 according to the embodiment or from undergoing reductive decomposition reaction in the negative electrode 7 according to the embodiment, which results in high durability to charge and discharge cycles.

In particular, when the positive electrode material mixture layer 3 contains the high-dielectric inorganic solid 13 in the lithium-ion secondary battery 1, the positive electrode has effectively improved durability to output power and charge and discharge cycles.

When the positive electrode material mixture layer 3 contains the high-dielectric inorganic solid 13, the content of the high-dielectric inorganic solid 13 in the positive electrode material mixture layer 3 is preferably in the range of 0.5 to 5% by mass based on the total mass of the positive electrode material mixture layer 3. This is effective in improving the durability of the positive electrode. Preferably, 1 to 30% of the surface area of the positive electrode active material 11 is covered with the high-dielectric inorganic solid 13.

If more than 30% of the surface area is covered with the high-dielectric inorganic solid 13, resistance against transfer of lithium ions to the positive electrode active material 11 may be too high and the durability may decrease. If less than 1% of the surface area of the positive electrode active material 11 is covered with the high-dielectric inorganic solid 13, the high-dielectric inorganic solid 13 may fail to produce the advantageous effect mentioned above.

In the lithium-ion secondary battery 1, the high-dielectric inorganic solid 13 contained in the negative electrode material mixture layer 6 can increase the charge capacity at low temperature and effectively improve the quick charge performance and durability.

When the negative electrode material mixture layer 6 contains the high-dielectric inorganic solid 13, the content of the high-dielectric inorganic solid 13 in the negative electrode material mixture layer 6 is preferably in the range of 0.1 to 1.0% by mass, more preferably 0.1 to 0.5% by mass, based on the total mass of the negative electrode material mixture layer 6. This is effective in improving the durability of the negative electrode. Preferably, 1 to 80% of the surface area of the negative electrode active material 12 is covered with the high-dielectric inorganic solid 13.

If more than 80% of the surface area is covered with the high-dielectric inorganic solid 13, resistance against transfer of lithium ions to the negative electrode active material 12 may be too high and the durability may decrease. If less than 1% of the surface area of the negative electrode active material 12 is covered with the high-dielectric inorganic solid 13, the high-dielectric inorganic solid 13 may fail to produce the advantageous effect mentioned above.

Although not shown in the drawings, the high-dielectric inorganic solid 13 becomes located between particles of the positive electrode active material 11 or the negative electrode active material 12, besides on the surface of the positive electrode active material 11 or the negative electrode active material 12, as the mass content of the high-dielectric inorganic solid 13 in the positive electrode material mixture layer 3 or the negative electrode material mixture layer 6 increases. The high-dielectric inorganic solid 13 located between particles of the positive electrode active material 11 or the negative electrode active material 12 can further reduce the internal resistance of the lithium-ion secondary battery.

When the high-dielectric inorganic solid 13 is located between particles of the positive electrode active material 11 or the negative electrode active material 12, the observed cross-section of the electrode material mixture layer preferably has a ratio of the cross-sectional area of the high-dielectric inorganic solid 13 to the cross-sectional area of the electrolytic solution 9 of 2/98 to 20/80. When the ratio is in that range, the high-dielectric inorganic solid 13 can accelerate the transfer of lithium ions in the electrolytic solution 9 between the particles while the high-dielectric inorganic solid 13 is prevented from interfering with the transfer.

Therefore, the lithium-ion secondary battery 1 in which the positive electrode material mixture layer 3 or the negative electrode material mixture layer 6 has a high mass content of the high-dielectric inorganic solid 13 can have lower internal resistance during continuous charge or discharge for, for example, electric vehicle (EV) operation.

Active Material

The positive electrode active material may be, for example, a lithium complex oxide (e.g., LiNiₓCo_{y}Mn_{z}O_{z} (x+y+z=1), LiNiₓCo_{y}Al_{z}O₂ (x+y+z−1)) or lithium iron phosphate (LiFePO_{z} (LFP)). One of these materials may be used, or two or more of these materials may be used in combination.

The negative electrode active material may be, for example, carbon powder (amorphous carbon), silica (SiOₓ), a titanium complex oxide (e.g., Li₄Ti₅O₇, TiO₂, Nb₂TiO₇), a tin complex oxide, a lithium alloy, or metallic lithium. One or more of these materials may be used. The carbon powder may be at least one of soft carbon (graphitizable carbon), hard carbon (non-graphitizable carbon), and graphite.

Conductive Aid

Examples of the conductive aid in the positive electrode material mixture layer 3 or the negative electrode material mixture layer 6 include carbon black, such as acetylene black (AB) and Ketjen black (KB), carbon materials, such as graphite powder, and electrically conductive metal powder, such as nickel powder. One of these materials may be used, or two or more of these materials may be used in combination.

Binder

Examples of the binder used in the positive electrode material mixture layer 3 or the negative electrode material mixture layer 6 include cellulose-based polymers, fluororesin, vinyl acetate copolymers, and rubbers. Specifically, when a solvent-based dispersion medium is used, examples of the binder include polyvinylidene fluoride (PVDF), polyimide (PI), polyvinylidene chloride (PVDC), and polyethylene oxide (PEO), and when a water-based dispersion medium is used, examples of the binder include styrene butadiene rubber (SBR), acrylic acid-modified SBP resin (SBR-based latex), carboxymethyl cellulose (CMC), polyvinyl alcohol (PVA), polytetrafiuoroethylene (PTFE), hydroxypropyl methyl cellulose (HPMC), and tetrafluoroethylene-hexafluoropropylene copolymer (FEP). One of these materials may be used, or two or more of these materials may be used in combination.

Current Collector

The positive electrode current collector 2 and the negative electrode current collector 5 may each be made of a foil or sheet of copper, aluminum, nickel, titanium, or stainless steel, a carbon sheet, or a carbon nanotube sheet. The current collector may be made of one of these materials, or if necessary, the current collector may be a metal clad foil made of two or more materials. The thickness of each of the positive electrode current collector 2 and the negative electrode current collector 5 is typically, but not limited to, 5 μm to 100 μm. For structure and performance improvement, the positive electrode current collector 2 and the negative electrode current collector 5 each preferably has a thickness in the range of 7 μm to 20 μm.

Separator

The separator 8 may be, but not limited to, a porous resin sheet (e.g., film, nonwoven fabric) made of a resin, such as polyethylene (PE), polypropylene (PP), polyester, cellulose, or polyamide.

Electrolytic Solution

The electrolytic solution 9 may include a non-aqueous solvent and an electrolyte. The concentration of the electrolyte is preferably in the range of 0.1 mol/L to 10 mol/L.

Non-Aqueous Solvent

Examples of the non-aqueous solvent in the electrolytic solution 9 include, but are not limited to, aprotic solvents, such as carbonates, esters, ethers, nitriles, sulfones, and lactones, specific examples include ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THE), 2-methyltetrahydrofuran, dioxane, 1,3-dioxolane, diethylene glycol dimethyl ether, ethylene glycol dimethyl ether, aeetonitrile (AN), propionitrile, nitromethane, N,N-dimethylformamide (DMF), dimethyl sulfoxide, sulfolane, and γ-butyrolactone.

Electrolyte

Examples of the electrolyte in the electrolytic solution 9 include LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y⇄3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ(Ti, Ge)₂₋ₓSi_{y}P_{3-y}O₁₂, and Li₄₋₂ₓZnₓGeO₄ (LISICON). Among them, LiPF₆, LiBF₄, or a mixture thereof is preferably used as the electrolyte.

The electrolytic solution 9 may also contain an ionic liquid or an ionic liquid and an aliphatic chain-containing polymer, such as polyethylene oxide (PEO) or polyvinylidene fluoride (PVDF) copolymer. The electrolytic solution 9 containing the ionic liquid can flexibly cover the surface of the positive electrode active material 11 or the negative electrode active material 12 so that contact sites are formed between the electrolytic solution 9 and the surface of the positive electrode active material 11 or the negative electrode active material 12.

The electrolytic solution 9 is filled in the space between the positive electrode material mixture layer 3 and the negative electrode material mixture layer 6 and in the pores of the separator 8. The electrolytic solution 9 is also stored at the bottom of the case 10. The mass percentage of the electrolytic solution S stored at the bottom of the case 10 may be in the range of 3 to 25% by mass based on the mass of the electrolytic solution 9 filled in the space between the positive electrode material mixture layer 3 and the negative electrode material mixture layer 6 and in the pores of the separator 8. The mass of the electrolytic solution 9 filled in the space between the positive electrode material mixture layer 3 and the negative electrode material mixture layer 6 and in the pores of the separator 8 can be calculated from the specific gravity of the electrolytic solution 9 and the total volume of the space between the positive electrode material mixture layer 3 and the negative electrode material mixture layer 6 and the pores of the separator 8, which can be measured, for example, with a mercury porosimeter. Alternatively, the total volume of the space between the positive electrode material mixture layer 3 and the negative electrode material mixture layer 6 and the pores of the separator 8 may be calculated from the densities of the positive electrode material mixture layer 3 and the negative electrode material mixture layer 6, the densities of the materials of each mixture layer, and the porosity of the separator 8.

The contact between the separator 8 and the electrolytic solution 9 stored in the case 10 allows the positive and negative electrode material mixture layers 3 and 6 to be replenished with the electrolytic solution 9 through the separator 8 upon the consumption of the electrolytic solution 9.

High-Dielectric Inorganic Solid

The high-dielectric inorganic solid 13 in at least one of the positive electrode material mixture layer 3 or the negative electrode material mixture layer 6 is highly dielectric. Solid particles obtained by pulverizing a crystalline solid have a permittivity lower than that of the original crystalline solid. Therefore, the high-dielectric inorganic solid according to the embodiment is preferably a product obtained by pulverization with the dielectric property kept as high as possible.

The high-dielectric inorganic solid for use in the present invention preferably has a relative permittivity of 10 or more, more preferably 20 or more when it is in the form of a powder. When polarized, the high-dielectric inorganic solid particles can trap an acid, which is produced through decomposition of the solvent or fluoride anions, such as PF₆⁻, on the negative electrode graphite surface. An acid produced in the secondary battery may corrode the positive electrode active material. The trapping of such an acid prevents the corrosion of the positive electrode active material and thus prevents charge and discharge-induced, active material cracking and metal elusion, so that the increase in the resistance of the secondary battery is kept at a low level during charge and discharge cycles. Therefore, the high-dielectric inorganic solid with a relative permittivity of 10 or more in the form of a powder can keep, at a low level, the increase in internal resistance during charge and discharge cycles and can reliably form a lithium-ion secondary battery with high durability to charge and discharge cycles. The high-dielectric inorganic solid particles can also trap an acid on the positive electrode surface to prevent the corrosion of the positive electrode active material.

In the present invention, the relative permittivity of the high-dielectric inorganic solid in the form of a powder may be determined as shown below. Method for Measuring Relative permittivity of Powder

The powder is placed in a 38 mm diameter (R) tablet molding machine for measurement, and compressed to a thickness (d) of 1 to 2 mm using a hydraulic press machine to give a compressed powder. The compressed powder is formed under such conditions as to achieve a powder relative density of 40% or more, which is calculated according to the formula: powder relative density (D_{powder})=(the weight density of the compressed powder/the true specific gravity of the dielectric)×100. The resulting molded product is measured for capacitance Cₜₒₜₐₗ at 25° C. and 1 kHz by automatic balancing bridge method using an LCR meter, and the relative permittivity εₜₒₜₐₗ of the compressed powder is calculated from the measurement. The permittivity ε_{powder} of the solid volume part (the relative permittivity ε_{powder} of the powder) may be calculated from the resulting relative permittivity of the compressed powder using Formulas (1) to (3) below, in which ε₀ is the permittivity of vacuum (=8.354×10⁻¹²) and εₐᵢᵣ is the relative permittivity of air (=1).

$$\begin{matrix}The contact area A between the compressed powder and the electrode = {( R / 2 )}^{2} \times \prod & ( 1 ) \\ {C}_{total} = {ɛ}_{total} \times {ɛ}_{0} \times ( A / d ) & ( 2 ) \\ {E}_{total} = {ɛ}_{powder} \times {D}_{powder} + {ɛ}_{air} \times ( 1 - {D}_{powder} ) & ( 3 )\end{matrix}$$

In order to improve the volume density of the active material filled in the electrode, the high-dielectric inorganic solid 13 preferably has a particle size of ⅕ or less of the particle size of the positive electrode active material 11 or the negative electrode active material 12, and more preferably has a particle size in the range of 0.02 μm to 1 μm. The high-dielectric inorganic solid 13 with a particle size of less than 0.02 μm may fail to maintain high dielectric property and may fail to effectively keep the increase in resistance at a low level.

The high-dielectric inorganic solid 13 preferably has ion conductivity, and more preferably has at least one of Li ion conductivity, Na ion conductivity, and Mg ion conductivity.

The high-dielectric inorganic solid 13 with the ion conductivity can trap a free solvent in the electrolytic solution 9 to form a quasi-solvation state. This results in effective stabilization of the solvent in the electrolytic solution 9 and makes the solvent less vulnerable to decomposition. From these points of view, the high-dielectric inorganic solid 13 preferably has an ionic conductivity of 10⁻⁷ S/cm.

As used herein, the term “ionic conductivity” refers to the value determined as shown below. Method of Determining Ionic Conductivity

An electrode was formed by Au sputtering on each side of a product obtained by sintering the high-dielectric inorganic solids 13 or on each side of a compressed powder obtained by molding the powder using a tablet molding machine. AC two-terminal method was carried out in which a voltage of 50 mV was applied across the resulting electrodes at a temperature of 25° C. and a frequency of 1 to 10⁶ Hz. The ionic conductivity k was calculated from the resulting resistance value Ri through calculating the real number at which the imaginary component of the impedance was zero. The measuring instrument may be, for example, Solartron 1260/1287. The ionic conductivity k is expressed by Formula (4) below, in which A′ is the area of Au, and l is the thickness of the high-dielectric inorganic solid 13.

$$k = 1 / ( Ri \times {A}^{′} ) ( S / cm ) \qquad ( 4 )$$

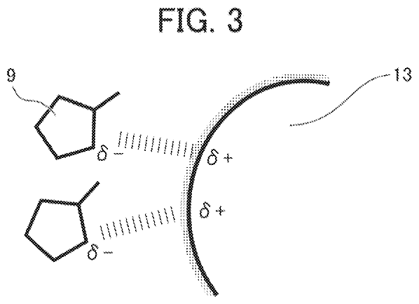

The high-dielectric inorganic solid 13 includes a Na- or Mg-based high-dielectric inorganic solid. As shown in FIG. 3, the Na- or Mg-based high-dielectric inorganic solid 13 can be easily polarized with δ⁺ in the electrolytic solution to form a solvation state with molecules in the electrolytic solution, so that it has a chemically stable, high dielectric effect on the electrolytic solution. Therefore, the Na- or Mg-based high-dielectric inorganic solid has high ability to trap the electrolytic solution, which improves the durability of the electrode.

The high-dielectric inorganic solid 13 is preferably, for example, Na₃₊ₓ(Sb₁₋ₓ, Snₓ)S₄ (0≤x≤0.1) or Na₃₋ₓSb₁₋ₓWₓS₄ (0≤x≤1). Specific examples include Na₃SbS₄, Na₂WS₄, and Na_{2.88}Sb_{0.88}W_{0.12}S₄.

The high-dielectric inorganic solid 13 preferably includes any one of an oxide, a fluoride, a chloride, and a sulfide. The high-dielectric inorganic solid 13 may have or may not have lithium ion conductivity. Preferably, the high-dielectric inorganic solid 13 is a solid electrolyte having lithium ion conductivity. The high-dielectric inorganic solid having lithium ion conductivity can form a lithium-ion secondary battery having higher power at low temperature. Therefore, a lithium-ion secondary battery electrode having high resistance to electrochemical oxidation or reduction can be produced at relatively low cost, and the cell weight is less likely to increase thanks to the low true specific gravity of the solid oxide electrolyte.

As mentioned above, at least one of the positive electrode material mixture layer 3 or the negative electrode material mixture layer 6 in the lithium-ion secondary battery 1 should contain the high-dielectric inorganic solid 13.

When the positive electrode material mixture layer 3 of the positive electrode 4 in the lithium-ion secondary battery 1 contains the high-dielectric inorganic solid 13, the high-dielectric inorganic solid 13 is preferably a sodium-based inorganic compound resistant to oxidative decomposition.

When the positive electrode material mixture layer 3 of the positive electrode 4 contains the oxidative decomposition-resistant, sodium-based inorganic compound, the high-dielectric inorganic solid in the positive electrode is resistant to oxidative decomposition, which makes it possible to achieve higher durability to charge and discharge cycles.

The oxidative decomposition-resistant, sodium-based inorganic compound preferably has an oxidative decomposition potential of 4.5 V or more relative to the Li/Li⁺ equilibrium potential (4.5 V vs Li/Li⁺).

If the oxidative decomposition-resistant, sodium-based inorganic compound has an oxidative decomposition potential of less than 4.5 V relative to the Li/Li⁺ equilibrium potential, the inorganic compound may undergo oxidative decomposition into component metal elements during charging, so that the metal elements may be dissolved and structural change may occur to reduce the ionic conductivity. If the lithium ion conductive solid electrolyte undergoes oxidation decomposition, charges may be consumed by the oxidative decomposition so that they may fail to be stored in the active material. This may result in fluctuations in the operational potential range of the lithium-ion secondary battery, a reduction in capacity, and significant degradation of durability to charge and discharge cycles.

The oxidative decomposition-resistant, sodium-based inorganic compound is preferably an oxide-based glass ceramic, such as Li_{1.6}Al_{0.6}Ti_{1.4}(PO₄)₃ or Li_{1+x+y}(Al, Ga)ₓ(Ti, Ge)₂₋ₓSi_{y}P_{3-y}O₁₂ (0≤x≤1, 0≤y≤1).

In particular, LATP (Li_{1.6}Al_{0.6}Ti_{1.4}(PO₄)₃), LAGP (Li_{1.5}Al_{0.5}Ge_{1.5}(PO₄)₃), or Li_{1+x+y}Alₓ(Ti, Ge)₂₋ₓSi_{y}P_{3-y}O₁₂(0≤x≤1, 0≤y≤1) is preferred.

When the negative electrode material mixture layer 6 of the negative electrode 7 in the lithium-ion secondary battery 1 contains the high-dielectric inorganic solid 13, the high-dielectric inorganic solid 13 is preferably a sodium-based inorganic compound resistant to reductive decomposition.

When the negative electrode material mixture layer 6 of the negative electrode 7 contains the reductive decomposition-resistant, sodium-based inorganic compound, the high-dielectric inorganic solid in the negative electrode is resistant to reductive decomposition, which makes it possible to achieve higher durability to charge and discharge cycles.

The reductive decomposition-resistant, sodium-based inorganic compound preferably has a reductive decomposition potential of 1.5 V or less relative to the Li/Li⁺ equilibrium potential (1.5 V vs Li/Li⁺).

If the reductive decomposition-resistant, lithium ion conductive solid electrolyte has a reductive decomposition potential of more than 1.5 V relative to the Li/Li⁺ equilibrium potential, the solid electrolyte may undergo reductive decomposition into component metal elements during charging, so that the metal elements may be dissolved and structural change may occur to reduce the lithium ion conductivity. If the sodium-based inorganic compound undergoes reductive decomposition, charges may be consumed by the reductive decomposition so that they may fail to be stored in the active material. This may result in fluctuations in the operational potential range of the lithium-ion secondary battery, a reduction in capacity, and significant degradation of durability to charge and discharge cycles.

While preferred embodiments of the present, invention have been described, the embodiments are not intended to limit the scope of the present invention and may be altered or modified as appropriate.

### EXAMPLES

Hereinafter, the present invention will be described in more detail with reference to examples. It will be understood that the examples are not intended to limit the scope of the present invention.

Synthesis of High-Dielectric Inorganic Solid

Synthesis of Na₃SbS₄

Na₃SbS₄ (NSS) was synthesized by the process shown below. In 2,210 mL of ion-exchanged water were dissolved 70.4 g of Na₂S, 75 g of Sb₂S₃, and 21 g of S and stirred at 70° C. for 5 hours. Subsequently, the mixture was cooled to 25° C., from which the undissolved product was removed. Subsequently, 1,400 mL of acetone was added to the product, and the mixture was stirred for 5 hours and then allowed to stand for 12 hours. The product was dried under reduced pressure at 200° C. to give Na₃SbS₄. The resulting sample was subjected to X-ray diffraction (XRD) measurement, which showed that the sample had Na₃SbS₄ (H₂O)₉ crystal phase.

Synthesis of Mg_{0.5}Si₂ (PO₄)₃

Mg_{0.5}Si₂ (PO₄)₃ (MSP) was synthesized by the process shown below. To 500 mL of a 5 mmol/L citric acid aqueous solution were added 6.07 g of magnesium acetate tetrahydrate, 6.80 g of silicon dioxide, and 19.52 g of monoammonium phosphate. The mixture was stirred at 30° C. for 2 hours using a stirrer and then refluxed at 70° C. for 24 hours. Subsequently, the mixture was heated and stirred at 80° C. for 24 hours using a stirrer. Subsequently, the mixture was heated at 150° C. for 24 hours so that the water and the organic materials were removed. The sample obtained after the heating was pulverized in an agate mortar and then heated at 400° C. for 4 hours. The resulting powder was compressed at 50 MPa using a tablet molding machine, and the compressed powder was heated at 800° C. for 3 hours. After a small amount of isopropyl alcohol (IPA) was added to the resulting sample, the sample was pulverized at 1,000 rpm for 10 minutes in a planetary ball mill using 2 mmφ Zr balls to give an MSP powder.

Synthesis of Mg_{0.5}Zr₂(PO₄)₃

Mg_{0.5}Zr₂(PO₄)₃ (MZP) was synthesized by the process shown below. To 250 mL of a 0.2 mmol/L nitric acid aqueous solution was added 23.79 g of zirconium acetate hydroxide. The mixture was stirred for 1 hour using a stirrer to give an aqueous solution. Separately, 4.47 g of magnesium acetate tetrahydrate and 14.3 g of monoammonium phosphate were added to 250 mL of distilled water and dissolved by stirring with a stirrer for 1 hour to form an aqueous solution. Subsequently, the two aqueous solutions were mixed and heated at 100° C. for 12 hours and then heated at 150° C. for 24 hours. The resulting sample was pulverized in an agate mortar and then heated at 400° C. for 4 hours. The resulting powder was compressed at 50 MPa using a tablet molding machine, and the compressed powder was heated at 800° C. for 3 hours. After a small amount of IPA was added to the resulting sample, the sample was pulverized at 1,000 rpm for 10 minutes in a planetary ball mill using 2 mmφ Zr balls to give a MZP powder.

The ionic conductivity of the NSS, MSP, MZP, and NZSP and the relative permittivity of the NSS, MSP, MZP, and NZSP in the form of a powder were measured. NZSP used was a commercially available product (manufactured by Toshima Manufacturing Co., Ltd.)

The results are shown in Table 1 below.

Positive and negative electrodes according to Examples 1 to 9 and Comparative Example 1 were prepared using the resulting high-dielectric inorganic solids. The composition of the electrode of each example is shown in Table 1.

Preparation of Positive Electrode

With Dielectric Particles

The dielectric particles of each example, acetylene black (AB) as an electron-conductive material, polyvinylidene fluoride (PVDF) as a binder, and N-methyl-2-pyrrolidone (NMP) as a dispersion medium were subjected to premixing and then wet mixing using a planetary centrifugal mixer to give a premix slurry. Subsequently, Li₁Ni_{0.5}Co_{0.2}Mn_{0.2}O₂ (NCM622) as a positive electrode active material was mixed with the resulting premix slurry. The mixture was subjected to a dispersion process using a planetary mixer to give a positive electrode material paste. Table 1 shows the weight content (wt %) of each component in the positive electrode material paste of each example. NCM622 had a median diameter of 12 μm. Next, the resulting positive electrode material paste was applied to a positive electrode current collector made of aluminum, then dried, and compressed using a roll press. The product was then dried in vacuo at 120° C. to form a positive electrode plate having a positive electrode material mixture layer. The resulting positive electrode plate was punched into a size of 30 mm×40 mm so that a positive electrode was obtained.

Preparation of Positive Electrode

Without Dielectric Particles

Acetylene black (AB) as an electron-conductive material, polyvinylidene fluoride (PVDF) as a binder, and N-methyl-2-pyrrolidone (NMP) as a dispersion medium were subjected to premixing and then wet mixing using a planetary centrifugal mixer to give a premix slurry. Subsequently, Li₁Ni_{0.6}Co_{0.2}Kn_{0.2}O₂ (NCM622) as a positive electrode active material was mixed with the resulting premix slurry. The mixture was subjected to a dispersion process using a planetary mixer to give a positive electrode material paste. The positive electrode material paste had a mass composition ratio of NCK622, AB, and PVDF of 94:4.2:1.8. NCM622 had a median diameter of 12 μm. Next, the resulting positive electrode material paste was applied to a positive electrode current collector made of aluminum, then dried, and compressed using a roll press. The product was then dried in vacuo at 120° C. to form a positive electrode plate having a positive electrode material mixture layer. The resulting positive electrode plate was punched into a size of 30 mm×40 mm so that a positive electrode was obtained.

Preparation of Negative Electrode

With Dielectric Particles

An aqueous solution of carboxymethyl cellulose (CMC) as a binder and acetylene black (AB) as an electron-conductive material were premixed using a planetary mixer. Subsequently, natural graphite (NG) as a negative electrode active material was added to the mixture and subjected to premixing using a planetary mixer. Subsequently, water as a dispersion medium and styrene butadiene rubber (SBR) as a binder were added to the mixture, which was subjected to a dispersion process using a planetary mixer to give a negative electrode material paste. Table 1 shows the weight content (wt %) of each component in the negative electrode material paste of each example. The natural graphite had a median diameter of 12 μm. Next, the resulting negative electrode material paste was applied to a negative electrode current collector made of copper, then dried, and compressed using a roil press. The product was dried in vacuo at 130° C. to give a negative electrode plate having a negative electrode material mixture layer. The resulting negative electrode plate was punched into a size of 34 mm×44 mm so that a negative electrode was obtained.

Preparation of Negative Electrode

Without Dielectric Particles

An aqueous solution of carboxymethyl cellulose (CMC) as a binder and acetylene black (AB) as an electron-conductive material were premixed using a planetary mixer. Subsequently, natural graphite (MG) as a negative electrode active material was added to the mixture and subjected to premixing using a planetary mixer. Subsequently, water as a dispersion medium and styrene butadiene rubber (SBR) as a binder were added to the mixture, which was subjected to a dispersion process using a planetary mixer to give a negative electrode material paste. The negative electrode material paste had a mass composition ratio of MG, AB, CMC, and SBR of 96.5:1.0:1.0:1.5. The natural graphite had a median diameter of 12 μm. Next, the resulting negative electrode material paste was applied to a negative electrode current collector made of copper, then dried, and compressed using a roll press. The product was dried in vacuo at 130° C. to give a negative electrode plate having a negative electrode material mixture layer. The resulting negative electrode plate was punched into a size of 34 mm×44 mm so that a negative electrode was obtained.

Preparation of Lithium-Ion Secondary Battery

An aluminum laminate (manufactured by Dai Nippon Printing Co., Ltd.) for a secondary battery was heat-sealed to form a bag-shaped case. A separator was placed between the positive and negative electrodes, which were prepared as shown above. The resulting laminate was placed in the case. After an electrolytic solution was injected into the interface between the electrodes, the case was sealed at a reduced pressure of 95 kPa so that a lithium-ion secondary battery was obtained. The separator was a polyethylene microporous membrane with its one side coated with alumina particles of about 5 μm. The electrolytic solution was a solution of 1.2 mol/L LiPF₆ as an electrolyte salt in a mixed solvent of ethylene carbonate, ethyl methyl carbonate, and dimethyl carbonate in a volume ratio of 30:30:40.

Evaluation

The lithium-ion secondary battery produced using the electrodes of each of Examples 1 to 9 and Comparative Example 1 was evaluated as shown below.

Initial Performance (Discharge Capacity)

The resulting lithium-ion secondary battery was allowed to stand at a measurement temperature (25° C.) for 1 hour, then charged at a constant current of 8.4 mA until 4.2 V was reached, subsequently charged at a constant voltage of 4.2 V for 1 hour, then allowed to stand for 30 minutes, and then discharged at a constant current of 8.4 mA until 2.5 V was reached. The process was repeated 5 times, in which the initial discharge capacity (mAh) was defined as the discharge capacity at the fifth discharge. The discharge capacity/charge capacity percentage ratio is also determined at the first cycle. Table 1 shows the results. The current value at which the discharge was completed in 1 hour was normalized to 1 C with respect to the resulting discharge capacity.

Initial Performance (Initial Cell Resistance)

After the measurement of the initial discharge capacity, the lithium-ion secondary battery was allowed to stand at a measurement temperature (25° C.) for 1 hour and then charged at 0.2 C such that the charge level (state of charge (SOC)) reached 50%, and then allowed to stand for 10 minutes. Subsequently, the lithium-ion secondary battery was pulse-discharged at a C rate of 0.5 C for 10 seconds, during which the voltage was measured. The current value was plotted on the horizontal axis, and the 10 second-discharge voltage for the current at 0.5 C was plotted on the vertical axis. Next, after being allowed to stand for 10 minutes, the lithium-ion secondary battery was supplementarily charged until SOC returned to 50%, and then further allowed to stand for 10 minutes. The operation shown above was performed at each of the C rates 1.0 C, 1.5 C, 2.0 C, 2.5 C, and 3.0 C, and the 10 second-discharge voltage was plotted against the current value at each C rate. The internal resistance (Q) of the lithium-ion secondary battery obtained in each example was defined as the slope of an approximate straight line obtained from the plots by least squares method. Table 1 shows the results.

Performance (Discharge Capacity) after Endurance Test In a thermostatic chamber at 45° C., the lithium-ion secondary battery was subjected to a charge and discharge cycle endurance test including 500 cycles of constant-current charging to 4.2 V at a charge rate of 1 C and then constant-current discharging to 2.5 V at a discharge rate of 2 C. After the completion of the 500 cycles, the lithium-ion secondary battery was allowed to stand for 24 hours in the thermostatic chamber with the temperature changed to 25° C., then charged at a constant current of 0.2 C until 4.2 V was reached, subsequently charged at a constant voltage of 4.2 V for 1 hour, then allowed to stand for 30 minutes, and then discharged at a discharge rate of 0.2 C until 2.5 V was reached. Subsequently, the discharge capacity (mAh) after the endurance test was measured. Table 1 shows the results.

Cell Resistance after Endurance Test

After the measurement of the discharge capacity after the endurance test, the lithium-ion secondary battery was charged until SOC (state of charge) reached 50% as in the measurement of the initial cell resistance. Subsequently, the cell resistance (Ω) after the endurance test was determined using the same method as for the measurement of the initial cell resistance. Table 1 shows the results.

Capacity Retention after Endurance Test

The capacity retention (%) was defined as the percentage ratio of the discharge capacity (mAh) after the endurance test to the initial discharge capacity (mAh). Table 1 shows the results.

Rate of Increase in Resistance after Endurance Test

The rate (%) of increase in cell resistance was defined as the percentage ratio of the cell resistance (Ω) after the endurance test to the initial cell resistance (Ω). Table 1 shows the results.

TABLE 1

| | | | | | | | | | | | | Compa- |
|---|---|---|---|---|---|---|---|---|---|---|---|---|
| | | | | | | | | | | | | rative |
| | | | Exam- | Exam- | Exam- | Exam- | Exam- | Exam- | Exam- | Exam- | Exam- | Exam- |
| | | | ple1 | ple2 | ple3 | ple4 | ple5 | ple6 | ple7 | ple8 | ple9 | ple1 |
| High- | Where to add | | Positive | Positive | Positive | Negative | Negative | Negative | Positive/ | Positive | Negative | Nowhere |
| dielectric | | | electrode | electrode | electrode | electrode | electrode | electrode | Negative | electrode | electrode | |
| inorganic | | | | | | | | | electrode | | | |
| solid | Positive | Type (abbreviation) | NZSP | NESP | NZSP | — | — | — | NZSP | MZP | — | — |
| | electrode | Content (wt %) | 0.5 | 1.0 | 5.0 | — | — | — | 1.0 | 1.0 | — | — |
| | | Relative permittivity | 27 | 27 | 27 | — | — | — | 27 | 25 | — | — |
| | | in powder form | | | | | | | | | | |
| | Negative | Type (abbreviation) | — | — | — | NSS | NSS | NSS | NSS | — | MSP | — |
| | electrode | Content (wt %) | — | — | — | 0.10 | 0.50 | 1.0 | 0.50 | — | 0.5 | — |
| | | Relative permittivity | — | — | — | 44 | 44 | 44 | 44 | — | 35 | — |
| | | in powder form | | | | | | | | | | |

| | | | | | | | | | | | |
|---|---|---|---|---|---|---|---|---|---|---|---|
| Positive | Positive electrode active material | 93.5 | 93.0 | 89.0 | 94.0 | 94.0 | 94.0 | 93.0 | 93.0 | 94.0 | 94.0 |
| electrode | High-dielectric inorganic solid | 0.5 | 1.0 | 5.0 | 0.0 | 0.0 | 0.0 | 1.0 | 1.0 | 0.0 | 0.0 |
| material | Acetylene black | 4.2 | 4.2 | 4.2 | 4.2 | 4.2 | 4.2 | 4.2 | 4.2 | 4.2 | 4.2 |
| composition | PVDF | 1.8 | 1.8 | 1.8 | 1.8 | 1.8 | 1.8 | 1.8 | 1.8 | 1.8 | 1.8 |
| Negative | Graphite particles | 96.5 | 96.5 | 96.5 | 96.4 | 96.0 | 95.5 | 96.0 | 96.5 | 96.0 | 96.5 |
| electrode | High-dielectric inorganic solid | 0.0 | 0.0 | 0.0 | 0.10 | 0.50 | 1.0 | 0.50 | 0.0 | 0.5 | 0.0 |
| material | Acetylene black | 1.0 | 1.0 | 1.0 | 1.0 | 1.0 | 1.0 | 1.0 | 1.0 | 1.0 | 1.0 |
| composition | CMC | 1.0 | 1.0 | 1.0 | 1.0 | 1.0 | 1.0 | 1.0 | 1.0 | 1.0 | 1.0 |
| (wt %) | SBR | 1.5 | 1.5 | 1.5 | 1.5 | 1.5 | 1.5 | 1.5 | 1.5 | 1.5 | 1.5 |
| Initial | Initial charge/discharge | 88.0 | 88.1 | 87.9 | 88.1 | 88.2 | 88.3 | 88.2 | 87.9 | 88.1 | 87.7 |
| performance | efficiency (%) | | | | | | | | | | |
| | Discharge capacity (mAh) | 42.3 | 42.0 | 40.2 | 42.5 | 42.5 | 42.5 | 42.6 | 43.0 | 42.5 | 42.5 |
| | Initial cell resistance (Ω) | 913.2 | 910.9 | 914.6 | 920.1 | 942.7 | 963.7 | 920.1 | 914.4 | 915.5 | 915.5 |
| Performance | Discharge capacity (mAh) | 38.0 | 37.9 | 38.0 | 38.4 | 38.8 | 37.7 | 37.6 | 38.4 | 38.4 | 37.4 |
| after endurance | Cell resistance after | 1200.0 | 1188.1 | 1176.5 | 1176.5 | 1182.3 | 1153.8 | 1224.5 | 1142.9 | 1165.0 | 1359.6 |
| | endurance test (Ω) | | | | | | | | | | |

| | | | | | | | | | | |
|---|---|---|---|---|---|---|---|---|---|---|
| Capacity retention after endurance test (%) | 89.9 | 90.1 | 94.4 | 90.3 | 91.2 | 88.7 | 88.3 | 89.3 | 90.3 | 88.1 |
| Rate of increase in resistance after | 131 | 130 | 129 | 128 | 128 | 120 | 133 | 125 | 127 | 149 |
| endurance test (%) | | | | | | | | | | |

The results in Table 1 indicate that the lithium-ion secondary battery of each of the examples has a capacity retention higher than that of the lithium-ion secondary battery of the comparative example after the endurance test and shows a rate of increase in resistance lower than that shown by the lithium-ion secondary battery of the comparative example after the endurance test. Therefore, it has been demonstrated that the lithium-ion secondary battery of each of the examples has high durability to charge and discharge cycles. It has also been demonstrated that the lithium-ion secondary battery of each of the examples has improved initial charge/discharge efficiency.

### EXPLANATION OF REFERENCE NUMERALS

1: Lithium-ion secondary battery

2: Positive electrode current collector

3: Positive electrode material mixture layer

4: Positive electrode

5: Negative electrode current collector

6: Negative electrode material mixture layer

7: Negative electrode

8: Separator

9: Electrolytic solution

10: Case

11: Positive electrode active material

12: Negative electrode active material

13: High-dielectric inorganic solid

What is claimed is:

1. An electrode for use in a lithium-ion secondary battery, the electrode comprising: an electrode material mixture layer comprising an electrode active material and a high-dielectric inorganic solid,
the electrode active material having a surface site in contact with the high-dielectric inorganic solid and having another surface site to be in contact with an electrolytic solution,
the high-dielectric inorganic solid being a Na- or Mg-based high-dielectric inorganic solid.

2. The electrode for use in a lithium-ion secondary battery according to claim 1, wherein the high-dielectric inorganic solid is provided between particles of the electrode active material or on a surface of a particle of the electrode active material.

3. The electrode for use in a lithium-ion secondary battery according to claim 1, wherein the high-dielectric inorganic solid is any one of an oxide, a fluoride, a chloride, and a sulfide.

4. The electrode for use in a lithium-ion secondary battery according to claim 1, being a negative electrode.

5. The electrode for use in a lithium-ion secondary battery according to claim 4, wherein the high-dielectric inorganic solid is a sodium-based inorganic compound resistant to reductive decomposition.

6. The electrode for use in a lithium-ion secondary battery according to claim 5, wherein the sodium-based inorganic compound resistant to reductive decomposition has a reductive decomposition potential of 1.5 V or less relative to a Li/Li⁺ equilibrium potential (1.5 V vs Li/Li⁺).

7. The electrode for use in a lithium-ion secondary battery according to claim 5, wherein the sodium-based inorganic compound resistant to reductive decomposition has a relative permittivity of 10 or more.

8. The electrode for use in a lithium-ion secondary battery according to claim 5, wherein the sodium-based inorganic compound resistant to reductive decomposition comprises Na³⁺ₓ(Sb₁₋ₓ, Snₓ)S₄, wherein 0≤x≤0.1.

9. The electrode for use in a lithium-ion secondary battery according to claim 5, wherein the electrode material mixture contains 0.1 wt % or more and 1.0 wt % or less of the sodium-based inorganic compound resistant to reductive decomposition.

10. The electrode for use in a lithium-ion secondary battery according to claim 1, being a positive electrode.

11. The electrode for use in a lithium-ion secondary battery according to claim 10, wherein the high-dielectric inorganic solid is a sodium-based inorganic compound resistant to oxidative decomposition.

12. The electrode for use in a lithium-ion secondary battery according to claim 11, wherein the sodium-based inorganic compound resistant to oxidative decomposition has an oxidative decomposition potential of 4.5 V or more relative to a Li/Li⁺ equilibrium potential (4.5 V vs Li/Li⁺).

13. The electrode for use in a lithium-ion secondary battery according to claim 11, wherein the sodium-based inorganic compound resistant to oxidative decomposition has a relative permittivity of 10 or more.

14. The electrode for use in a lithium-ion secondary battery according to claim 11, wherein the sodium-based inorganic compound resistant to oxidative decomposition is at least one of Na³⁺ₓ (Sb₁₋ₓ, Snₓ)S₄, wherein 0≤x≤0.1, and Na₃Zr₂Si₂PO₁₂.

15. The electrode for use in a lithium-ion secondary battery according to claim 11, wherein the electrode material mixture contains 0.5 wt % or more and 5.0 wt % or less of the sodium-based inorganic compound resistant to oxidative decomposition.

16. A lithium-ion secondary battery comprising the electrode according to claim 1.
